(19) United States
(12) Patent Application Publication
(10) Pub. No.: US 2012/0180324 A1
(43) Pub. Date: Jul. 19, 2012

(54) Ring Cutter for Twine or the Like

(76) Inventors: Brian L. Caldwell, Marion, OH (US); Joel D. Tschantz, Maumee, OH (US)

(21) Appl. No.: 13/421,033

(22) Filed: Mar. 15, 2012

Related U.S. Application Data
(63) Continuation-in-part of application No. 12/379,020, filed on Feb. 11, 2009, now abandoned.

(51) Int. Cl. B26B 27/00

(52) U.S. Cl. 30/298

(57) ABSTRACT

A ring cutter for twine or the like, comprising a ring adapted to fit on the finger of a user and having a pair of side portions joined at the upper end thereof and separated at the lower end thereof by a space therebetween. The ring is formed of a flexible and resilient material. A bracket extends upwardly from the upper portion of the ring and a cutting blade is secured to the bracket and extends forwardly therefrom. The lower ends of the side portions of the ring are separable to enable a finger of a user to be removed from the ring through the space between the side portions by the application of a downward force by the finger on the lower ends of the side portions. The lower ends may be connected by a narrow tab that can be cut or is frangible.

### CROSS REFERENCE TO RELATED APPLICATION

This application is a continuation-in-part of application Ser. No. 12/379,020 filed on Feb. 11, 2009.

### BACKGROUND OF THE INVENTION

1. Field Of The Invention

The present invention relates to a cutter for twine or the like and, more particularly, to a new and improved cutter in the form of a ring which fits on the finger of a user.

2. Description of Related Art

Although cutters for twine or the like in the form of a ring that can be worn on a finger have been in use for many years and have generally served their purpose, they have been subject to one or more of the following disadvantages:

1. They have been complicated in construction and thus expensive to manufacture;

2. They have been uncomfortable on a finger of a user; and/or

3. They have been difficult to remove quickly from the finger of a user in cases where the cutter is inadvertently retained or caught in an adjacent device, piece of equipment or the like.

The new and improved ring cutter of the present invention is not subject to the above-described disadvantages and possesses advantages not found in previously used ring cutters.

### BRIEF SUMMARY OF THE INVENTION

The ring cutter of the present invention comprises a ring having a pair of flexible and resilient side portions that are connected at the upper end thereof and separated at the lower end thereof by a space therebetween, An upstanding bracket is secured to the upper end of the ring and a cutting blade is secured to the bracket and extends forwardly from the ring in generally parallel relation to the longitudinal axis of the ring. The upper end of the ring may be offset rearwardly from the lower split end thereof to enable the ring to fit more comfortably on a finger of a user, such as the little finger.

The ring, bracket and cutting blade may be formed of any suitable materials and may be secured together in any suitable manner, such as by molding, adhesive, rivets or the like.

In the event the ring or cutting blade should become caught or jammed in an adjacent device or piece of machinery or the like, the user can pull his or her finger against the lower spaced ends of the side portions of the ring to cause them to separate and allow the finger of the user to be easily removed from the ring to prevent injury to the finger or hand of the user.

In a modified embodiment, the lower spaced ends of the side portions of the ring are connected by a narrow tab that can be cut or otherwise broken to allow the lower spaced ends to separate. This embodiment will allow a user to use the ring with the lower spaced ends being connected or being separated.

Alternatively, the narrow tab can be frangible so that it will break when a sufficient force is applied to it by the user, either voluntarily or in response to a force applied to it in the event the ring or cutting blade is caught or jammed in an adjacent device or piece of machinery.

### BRIEF DESCRIPTION OF THE DRAWINGS

FIG. 1 is a perspective view of the front portion of one embodiment of the ring cutter of the present invention;

FIG. 2 is a perspective view of the rear portion of the ring cutter shown in FIG. 1;

FIG. 3 is a front elevational view of the ring cutter of FIG. 1;

FIG. 3A is a front elevational view like FIG. 3 showing the separation of the side portions of the ring of the ring cutter;

FIG. 4 is a side elevational view of the ring cutter of FIG. 1, with parts broken away;

FIG. 5 is a perspective view of the front portion of a second embodiment of the ring cutter of the present invention; and

FIG. 6 is a front elevational view of the ring cutter shown in FIG. 5;

FIG. 7 is a perspective view of a third embodiment of the ring cutter;

FIG. 8 is bottom plan view of the ring cutter shown in FIG. 7;

FIG. 9 is a front elevational view showing the separation of the side portions of the ring of the ring cutter shown in FIGS. 7 and 8; and

FIG. 10 is a perspective view of a fourth embodiment of the ring cutter.

### DETAILED DESCRIPTION OF THE INVENTION

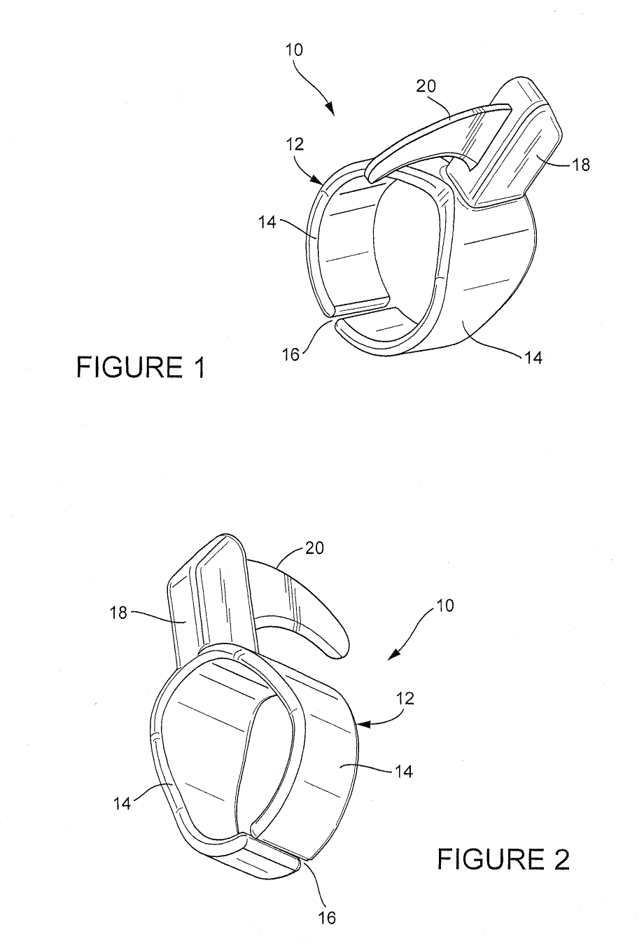

As shown in FIGS. 1-4, the ring cutter 10 of the present invention comprises a ring 12 of a size and configuration to fit on a finger of a user, such as the little finger (not shown). The ring 12 comprises side portions 14 that are joined at the upper end of the ring and are separated at the lower end of the ring by a space 16 therebetween. The ring 12 and side portions 14 thereof may be formed of any suitable flexible and resilient material, e.g., plastic such as polycarbonate or polypropylene, or metal such as aluminum.

A bracket 18 of any suitable construction extends upwardly from the upper end of the ring 12 and has a cutting blade 20 mounted thereon in any suitable manner. The bracket 18 may be molded in one piece with the ring 12 or may be secured thereto in any suitable manner. The bracket 18 may be formed of any suitable material, such as the material of the ring member 12.

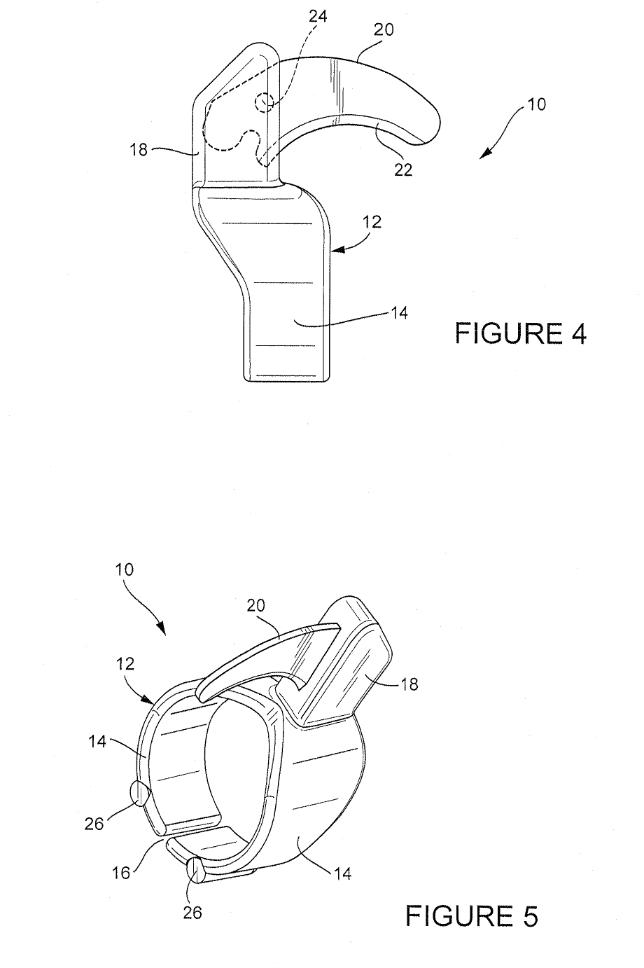

The cutting blade 20 may be of any suitable material or construction, and may be secured to the bracket 18 by molding, adhesive, rivets or in any other suitable manner. As shown in FIG. 4, the cutting blade 20 extends forwardly from the bracket 18, may be generally concave in shape and has a cutting edge 22 on the lower portion thereof. Preferably, the outer or forward end of the cutting blade 20 is blunt for safety purposes. In one embodiment, the inner end of the cutting blade 20 may be formed with laterally extending projections 24 to retain it in the bracket 18 when molded in place therein.

As shown in FIG. 4, the upper portion of the ring 12 may be offset rearwardly from the lower portion thereof so that the ring can fit comfortably and securely on the inner end of the finger of a user.

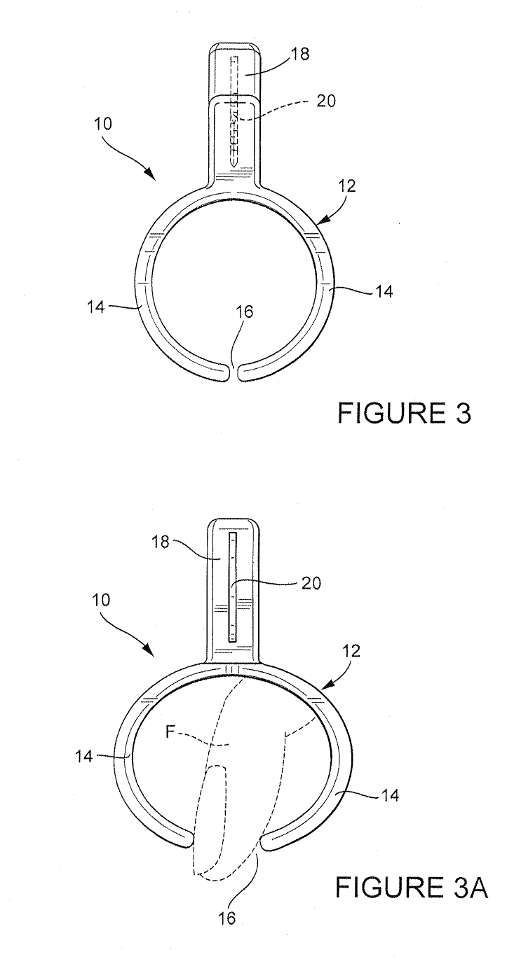

As shown in FIG. 3A, the side portions 14 of the ring 12 are constructed to be sufficiently flexible to separate at the lower ends thereof to allow the finger F of a user to be removed from the ring 12 by pulling downwardly on the lower ends of the side portions 14 in the event the ring cutter 10 should be inadvertently caught or retained in an adjacent device or piece of equipment to prevent injury to the finger or hand of the user.

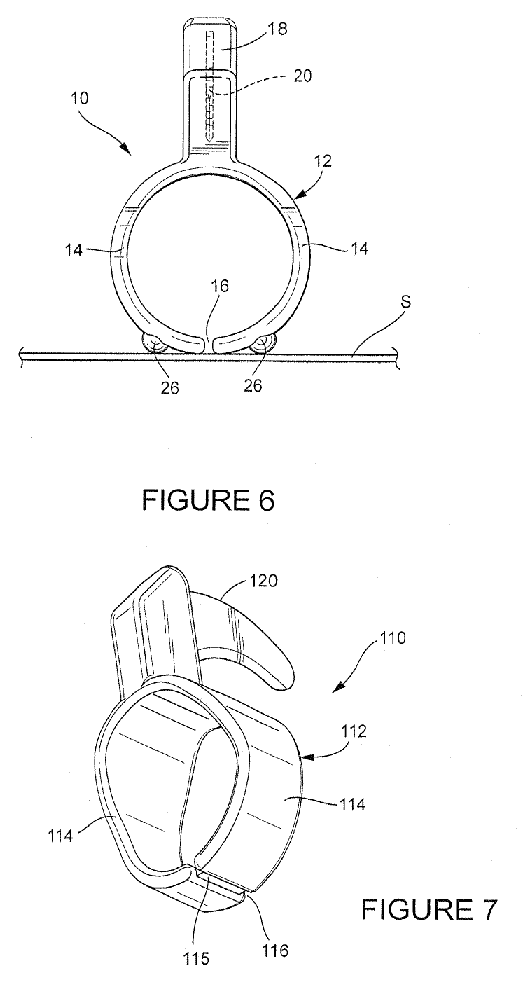

In a second embodiment of the ring cutter shown in FIGS. 5 and 6, the lower ends of the side portions 14 of the ring 12 may be provided with legs 26 of any suitable construction to enable the ring cutter 10 to be supported in an upright manner on a support surface S (FIG. 6). As shown in FIG. 5, the legs 26 may be in the form of generally cylindrical members formed integrally with the side portions 14 of the ring member 12 or secured thereto in any suitable manner.

In the use of the ring cutter 10 of the present invention, the ring 12 may be positioned on the inner end of a finger of the user, such as the little finger, with the cutting blade 20 extending forwardly. The cutting blade 20 can then be used to cut twine, thread or any other material by appropriate movement of the finger or hand of the user. The ring cutter 10 of the present invention is especially useful, for example, by persons who tie up bundles, packages or the like with twine or the like. The separation of the lower ends of the side portions of the ring 12 provides a safety feature in that it enables the finger of a user to be easily removed from the ring 12 by the separation of the side portions 14 by pulling downwardly against the lower ends of the side portions 14 to cause them to separate in the event the ring cutter becomes inadvertently caught or retained in an adjacent device or piece of equipment.

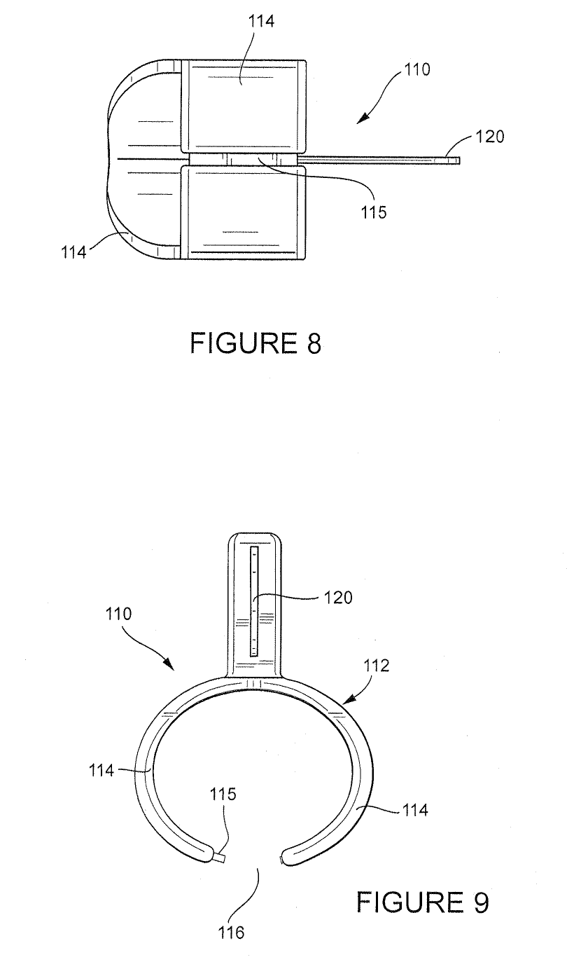

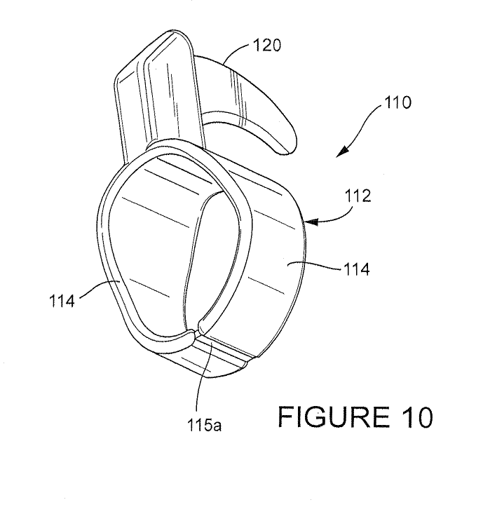

In a third embodiment of the ring cutter 110 shown in FIGS. 7-9, the lower spaced ends of the side portions 114 of the ring 112 are connected by a narrow tab 115 which can be cut or otherwise broken to allow the spaced ends to separate at 116 as shown in FIG. 9 at the option of a user. Alternatively, the tab 115 may be frangible so that it will break when a sufficient force is applied to it by a user, either voluntarily or in response to a force applied to it in the event the ring 112 or cutting blade 120 becomes caught or jammed in an adjacent device or piece of machinery. The tab 115 may be of any suitable size and shape. For example the tab 115a may be of the same size as the side portions 114 as shown in FIG. 10.

Because of the simple construction of the ring cutter 10, it may be molded in one piece construction to enable it to be simple and inexpensive to manufacture. It may also be constructed in any other suitable manner.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A ring cutter for twine, comprising:
a ring adapted to fit on a finger of a user and having a pair of side portions joined at an upper end thereof and separated at lower ends thereof by a space therebetween, said ring being formed of a flexible and resilient material;
said ring being of a size to receive the finger of the user therein without deformation of the side portions, the lower ends of the side portions being closely adjacent to each other at the space therebetween;
a bracket extending upwardly from the upper end of said ring; and
a cutting blade secured to said bracket and extending forwardly therefrom;
wherein the lower ends of said side portions of said ring are separable to enable the finger of the user to be removed from said ring through an enlarged space between said side portions by the application of a downward force by the finger on the lower ends of said side portions.

2. The ring cutter of claim 1 wherein said ring and said bracket are of a unitary molded construction formed of a plastic material.

3. The ring cutter of claim 2 wherein said cutting blade is formed of plastic material and is of unitary molded construction with said ring and said bracket.

4. The ring cutter of claim 2 wherein said cutting blade is formed of metal and said bracket is molded thereto, said cutting blade having laterally extending projections to retain it within said molded bracket.

5. The ring cutter of claim 2 wherein said cutting blade is concave with a lower cutting edge and a forward blunt end.

6. The ring cutter of claim 5 wherein said cutting blade extends forwardly in generally parallel relation to the longitudinal axis of said ring.

7. The ring cutter of claim 1 wherein the upper end of said ring is offset inwardly from the lower end of said ring to enable said ring to fit comfortably and securely on the inner end of the finger of the user.

8. The ring cutter of claim 1 wherein the lower ends of said side portions of said ring have downwardly extending legs to enable the ring cutter to be supported in an upright position on a support surface.

9. The ring cutter of claim 8 wherein said legs are of generally cylindrical configuration and extend in generally parallel relation to the longitudinal axis of said ring.

10. A ring cutter for twine, comprising:
a ring adapted to fit on a finger of a user and having a pair of side portions joined at an upper end thereof and separated at lower ends thereof by a space therebetween, said ring being formed of a flexible and resilient material;
said ring being of a size to receive a finger of the user therein without deformation of the side portions;
a bracket extending upwardly from the upper end of said ring; and
a cutting blade secured to said bracket and extending forwardly therefrom;
the spaced lower ends of said side portions of said ring being connected by a narrow tab that can be cut or broken by a user to allow the spaced lower ends of said side portions to separate to enable a finger of the user to be removed from the ring through an enlarged space between said side portions by the application of a downward force by the finger on the lower ends of said side portions.

11. The ring cutter of claim 10 wherein said narrow tab is frangible so that it will break when a sufficient downward force is applied to it by a finger of the user to allow the spaced lower ends of said side portions to separate.
